(19) United States
(12) Patent Application Publication
(10) Pub. No.: US 2002/0058122 A1
(43) Pub. Date: May 16, 2002

(54) Insert molded product

(76) Inventors: Tsuyoshi Arai, Kariya-city (JP); Yoshitaka Kamiya, Anjo-city (JP); Tsutomu Onoue, Kariya-city (JP); Takeshi Murata, Chiryu-city (JP); Takao Segi, Inabe-gue (JP); Hiroyuki Tsuge, Nisshin-city (JP)

Correspondence Address: LAW OFFICE OF DAVID G POSZ, 2000 L STREET, N.W., SUITE 200, WASHINGTON, DC, 20036, US

(21) Appl. No.: 09/985,178

(22) Filed: Nov. 1, 2001

(30) Foreign Application Priority Data
Nov. 6, 2000 (JP) 2000-3381 49

(51) Int. Cl. B32B 7/00

(52) U.S. Cl. 428/98

(57) ABSTRACT

In an insert molded product 10 according to the present invention, a primary molded part 2 formed around an insert member 1 in primary molding has an external surface of convexo-concave shape in which convex portions 2a, 2a′ and concave portions 2b, 2b′, alternately arranged in the longitudinal direction of the insert member, and a secondary molded part 3 formed around the primary molded part in a secondary molding has an external surface which is generally flat in parallel to the longitudinal direction of the insert member. Therefore, in the secondary molded part also, convex portions 3a, 3a′ and concave portions 3b, 3b′ are alternately arranged. A protrusion 7 for welding is provided on the convex portion of primary molded part in the rear of the convex portion 2a that is provided on the primary portion for regulation of flow at the time of secondary welding.

### BACKGROUND OF THE INVENTION

1. Field of the Invention

The present invention relates to a resin molded product, and more particularly to an insert molded product formed in an insert molding process in which a primary molded part formed in primary molding is used as an insert in secondary molding to be further insert-molded with a molding resin.

2. Description of the Related Art

A conventional two-step molding process is known in which plural insert members are set in a metal mold and insert-molded with a molding resin to obtain a primary molded product, and the primary molded product is used as an insert to be further molded with a molding resin to obtain a secondary molded product. However, gaps, though small, inevitably occur in the interfaces between the inserts and the primary molded product and between the primary and the secondary molded products. Moisture, air, oil, and the like tend to penetrate into the gaps, giving rise to a problem, for example, such as that when the insert members are metal electric terminals, the insulating resistance between the terminals is degraded.

As a prior art technology for solving the problem of insufficient air-tightness, a molding method for forming an insert molded product is known, as disclosed in Japanese Patent Publication (Kokai) No. 09-300401. According to this method of forming an insert molded product 10, as shown in FIGS. 5 and 6, air-tightness between an insert member 1 and a primary molded part 2 is provided by applying a sealant 4 (such as hydrin rubber) to the insert member 1, and air-tightness between the primary molded part 2 and the secondary molded part 3 is achieved by forming protrusion 2A on the primary molded part 2 and melting this protrusion 2A during the secondary molding process by way of the heat of the molten molding resin so as to weld the primary molded part 2 to the secondary molded part 3 and achieve the desired level of air-tightness of the insert molded product 10.

However, the welded portion between the primary molded part 2 and the secondary molded part 3 in this case is located around the center of the product, and for structural reasons, the gate for injecting the molding resin in the secondary molding cannot be disposed at the center. As a result, the flow of resin cannot be made uniform, and therefore the temperature and pressure of resin in the welded portion vary from place to place. In particular, the temperature of the resin is lower on the side opposite the position of the gate, which may lead to poor welding of the protrusion 2A of the primary molded part 2 to the secondary molded part 3, and thus satisfactory air-tightness may not be possible to obtain.

### SUMMARY OF THE INVENTION

It is an object of the present invention to solve the above problem and to provide an insert molded product having improved air-tightness between an insert member and a primary molded part, and between primary and secondary molded parts.

To attain the object as described above, according to an aspect of the present invention, an insert molded product is provided which is insert-molded in two steps of primary and secondary insert molding, wherein the primary molded part is of convexo-concave shape with at least two sets of thick wall portions of high resin thickness and thin wall portion of low resin thickness alternately formed along the direction parallel to the longitudinal direction of the insert member, and the secondary molded part that is formed around the primary molded part is also of convexo-concave shape with at least two sets of thick wall portions of high resin thickness and thin wall portion of low resin thickness alternately formed along the direction parallel to the longitudinal direction of the insert member. Close contact between the insert member and the primary molded part in primary insert molding may be thereby realized so that air-tightness of the primary molded part can be improved, and similarly close contact between the primary molded part and the secondary molded part in secondary insert molding may be thereby realized so that air-tightness of the secondary molded part can be improved.

According to another aspect of the present invention, an insert molded product is provided wherein the primary molded part and the secondary molded part are formed, respectively, by the primary insert molding resin and the secondary insert molding resin injected at the thick wall portion thereof and flowing along the longitudinal direction of the insert member successively through the two sets of thick wall portions and thin wall portions. Thus, at the time of the primary molding and the secondary molding, the molding resin is first injected in the circumferential direction of the thick wall portion, and then spreads into the thin wall portion in a uniform and regulated resin flow so that no circumferential variation in air-tightness occurs between the primary molded part and the secondary molded part and overall air-tightness can be thereby improved.

According to another aspect of the present invention, an insert molded product is provided wherein a protrusion is formed on the circumference of the primary molded part corresponding to the thin wall portion on the downstream portion of the flow of the secondary insert molding resin. The flow resistance of the secondary insert molding resin is thereby increased so that the flow of resin can be effectively regulated. In addition, the protrusion is effectively melted at the time of secondary molding and closer contact can be thereby obtained.

According to still another aspect of the present invention, an insert molded product is provided wherein a sealant is applied to the circumference of the insert member in advance. Close contact of the primary molded part, and hence air-tightness, is thereby improved.

According to still another aspect of the present invention, an insert molded product is provided wherein the length (height) of the thick wall portion of the primary molded part along the longitudinal direction of the insert member is greater than the thickness of the thin wall portion. As a result, uniformity of flow of resin at the time of primary molding is further improved.

According to still another aspect of the present invention, an insert molded product is provided wherein the length (height) of the thick wall portion of the secondary molded part along the longitudinal direction of the insert member is greater than the thickness of the thin wall portion. As a result, uniformity of flow of resin at the time of secondary molding is further improved.

According to still another aspect of the present invention, a resin molded product comprising a primary molded part and a secondary molded part is provided wherein, relative to the flow direction of the secondary molding resin that forms the secondary molded part, a first ring-like protrusion is provided on the circumference of the primary molded part, and in addition, a restriction portion is provided on the upstream side of the ring-like protrusion in the resin flow for narrowing the flow of the secondary molding resin so that the flow of the secondary molding resin can be regulated by the restriction portion and the timing of arrival of the secondary molding resin at the first ring-like protrusion can be synchronized. Uniform welding can be thereby obtained over the whole circumference of the protrusion so that stable sealing performance can be achieved.

According to still another aspect of the present invention, a resin molded product is provided wherein the thickness of the secondary molding part at the restriction portion is smaller than the separation between the restriction portion and the first ring-like protrusion. As a result, the secondary molding resin arrives uniformly at the first ring-like protrusion.

According to still another aspect of the present invention, a resin molded product is provided wherein the secondary molded part in the resin flow on the downstream side of the thin wall portion of the secondary molded part that is formed by the first ring-like protrusion has a resin thickness greater than the thickness of the thin wall portion, and a length of at least three times the thickness of the thin wall portion. Adequate heat may be thereby supplied from the secondary molding resin to the first ring-like protrusion so as to ensure sufficient melting of the protrusion and provide closer contact between the primary molded part and the secondary molded part.

The present invention may be more fully understood from the description of preferred embodiments of the invention, as set forth below, together with the accompanying drawings.

### BRIEF DESCRIPTION OF THE DRAWINGS

FIGS. 1A and 1B are a plan view and a longitudinal sectional view, respectively, showing a primary molded part at the stage of primary molding of an insert molded product according to an embodiment of the present invention;

FIG. 2 is a longitudinal sectional view showing an insert molded product at the end of secondary molding according to the embodiment of FIGS. 1A and 1B;

FIG. 3 is a sectional view with a partially enlarged sectional view showing a resin molded product according to another embodiment of the present invention;

FIG. 4 is a sectional view with a partially enlarged sectional view showing a resin molded product according to still another embodiment of the present invention;

FIG. 5 is a perspective view showing the primary molded part of a prior art insert molded product at the stage of primary molding; and

FIG. 6 is a longitudinal sectional view showing the prior art insert molded product at the end of secondary molding.

### DESCRIPTION OF THE PREFERRED EMBODIMENTS

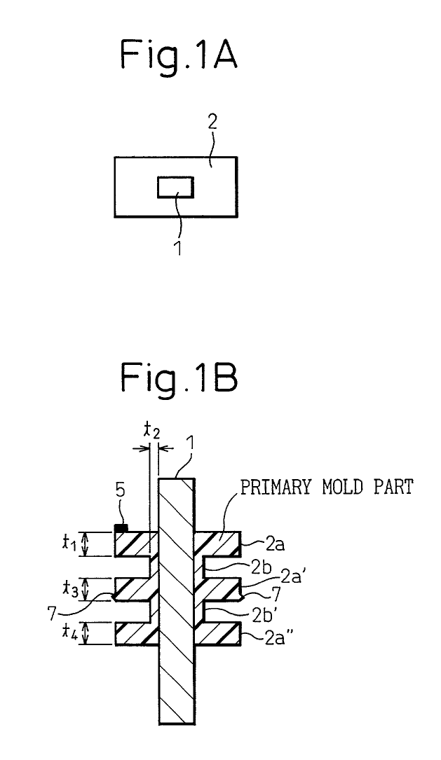

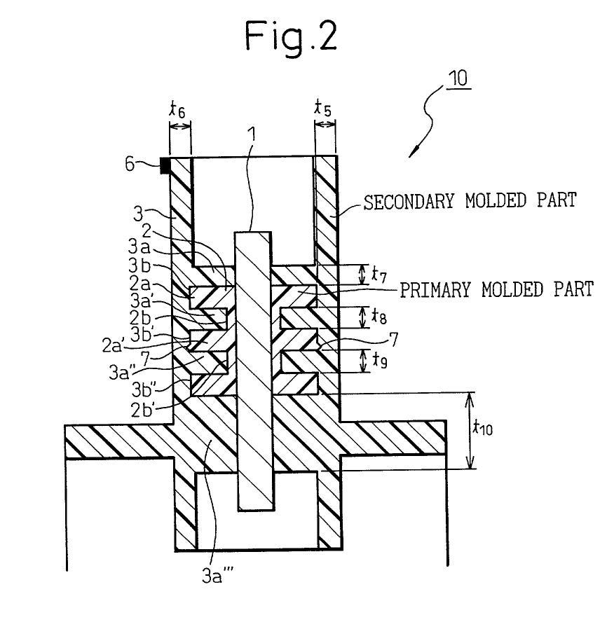

An insert molded product of the present invention will now be described with reference to the drawings showing embodiments thereof. FIGS. 1A and 1B are a plan view and a longitudinal sectional view, respectively, showing a primary molded part of an insert molded product of the present invention at the stage of primary molding, and FIG. 2 is a longitudinal sectional view showing an insert molded product of the present invention at the end of secondary molding.

The insert molded product 10 of the present invention is comprised of an insert member 1, a primary molded part 2 and a secondary molded part 3. Reference numeral 5 in FIG. 1B denotes a gate through which molding resin is injected at the time of primary molding, and reference numeral 6 in FIG. 2 denotes a gate through which molding resin is injected at the time of secondary molding.

The primary molded part 2 is comprised of a first convex portion (thick wall portion) 2a, a first concave portion (thin wall portion) 2b for homogenizing the flow of molding resin at the time of primary molding, a second convex portion (thick wall portion) 2a′, a second concave portion (thin wall portion) 2b′ provided on the circumference of the part of insert member 1 where air-tightness is required between the insert member 1 and the primary molded part 2 at the time of primary molding, and protrusion 7 for regulation of flow provided on the convex portions downstream of the first concave portion 2b. Thus, in addition to the above mentioned protrusion 7, the primary molded part 2 is provided with at least two sets of alternating convex and concave portions, so that the external surface is of convexo-concave shape. The lengths (heights) t1, t3 of the convex portions (thick wall portions) 2a, 2a′ along the longitudinal direction of the insert member, and the thickness t2 of the concave portions (thin wall portions) 2b, 2b′, are set such that relations t1>t2, t3>t2 are satisfied. A convex portion 2c is additionally provided on the downstream side of the second concave portion 2b′ in the resin flow, and the length t4 of the convex portion 2c is also set to be greater than the thickness t2 of concave portions 2b, 2b′ (t4>t2).

On the other hand, the secondary molded part 3 has an external surface that is parallel to the insert member 1 and is generally flat. The internal surface of the secondary molded part 3 is of convexo-concave shape so as to engage with the indented shape of the external surface of the primary molded part, except for the protrusion provided for regulation of flow on the convex portion of the primary molded part downstream of the first concave portion 2b. In other words, corresponding to the first convex portion 2a of the primary molded part 2, a first concave portion (thin wall portion) 3b is formed on the secondary molded part 3. When the secondary molding resin flows through the first concave portion 3b, the flow of resin is homogenized. On the upstream side of the first concave portion 3b in the flow of resin, a first convex portion 3a is formed, and the secondary molding resin injected through the gate 6 flows into the first convex portion 3a to fill it. Further, corresponding to the first concave portion 2b of the primary molded part 2, a second convex portion (thick wall portion) 3a′ is formed on the secondary molded part 3. Similarly, corresponding to the second convex portion 2a′, and protrusion 7 on the convex portion of the primary molded part 2, a second concave portion (thin wall portion) 3b′ is formed on the secondary molded part 3, and corresponding to the second concave portion 2b′, of the primary molded part 2, a third convex portion (thick wall portion) 3a″ is formed on the secondary molded part 3, respectively. On the downstream side of the third convex portion 3a″, a third concave portion 3b″ is further formed.

Also in the secondary molded part 3, lengths (heights) t7, t8, t9 of the convex portions 3a, 3a′, 3a″ and thickness t5 of the concave portion 3b, 3b′, 3b″ are set such that relations t7>t5, t8>t5, t9>t5 are satisfied.

With this construction, the flow resistance of the secondary molding resin at the concave portions 3b, 3b′, 3b″ is increased, and effective regulation of flow at the first concave portion 3b and the effect of improved closer contact due to increased pressure at the second concave portion 3b′ are also obtained.

In order to increase the flow resistance at concave portions 3b, 3b′, 3b″, resin thickness t6 from the gate 6 to the first convex portion 3a is also made greater than the thickness t5 of the concave portions 3b, 3b′, 3b″ (t6>t5).

In order for the heated secondary molding resin to be able to flow through the second concave portion 3b′ and melt the protrusion 7 formed on the circumference of the primary molded portion, length t10 of a fourth convex portion 3a″′ on the downstream side of the third concave portion 3b″ satisfies the relation t10/t5>3.

In this manner, in the insert molded product according to this embodiment of the present invention, two or more concave portions (thin wall portions) and two or more convex portions (thick wall portions) are formed on the entire circumference of the primary molded part 2 and the secondary molded part 3, respectively, so as to improve air-tightness.

Although cross section of the insert member 1 is shown as rectangular in FIG. 1, the insert member may be of any form in cross section; it may, for example, be of circular or polygonal cross section.

Next, the primary molding will be described in detail with reference to FIG. 1.

In the interface between the insert member 1 and the primary molded part 2, at the time of primary molding, because of the above-mentioned relation t1>t2, the molten resin injected from the primary molding gate 5 is first filled in the direction of the thick circumferential portion containing the first convex portion (thick wall portion) 2a, before the resin flows into the first concave portion (thin wall portion) 2b. The molten resin is subsequently filled into the first concave portion 2b which is a thin wall portion. In this manner, the flow of the primary molding resin is made uniform by the first concave portion 2b. Then, the primary molding resin flows through the second convex portion 2a′ and the protrusion 7 provided for welding (at the time of secondary molding) on the convex portion 2a′, and into the second concave portion (thin wall portion) 2b′ provided on the overall circumference where air-tightness of the primary molded part 2 is required. Since the resin flow has been homogenized in the first concave portion 2b, the flow is also homogenized and uniform in the second concave portion 2b′, so that variations in air-tightness (close contact) do not arise and overall air-tightness is improved. Since the wall of the second concave portion 2b′ provided over the entire circumference in the portion of primary molded part 2, where high air-tightness is required, is thin, the resin pressure becomes high, so that transcription performance is improved. Therefore, air-tightness between the insert member 1 and the primary molded part 2 is improved.

In the case where a sealant 4 is applied to the insert member 1, since the thickness of the second concave portion 2b′ provided on the entire circumference, where air-tightness of the primary molded part is required, is small, pressure and shear-generated heat become high. Thus, high compression of the sealant 4, high reactivity of the sealant 4 due to heat and pressure, etc. cause the air-tightness between the insert member 1 and the primary molded part 2 to be improved further.

Next, the secondary molding will be described with reference to FIG. 2.

In the interface between the primary molded part 2 and the secondary molded part 3, at the time of secondary molding, the molten resin injected from the secondary molding gate 6 is first filled into the first convex portion 3a, before the resin flows into the first concave portion 3b that is thin wall portion. The resin is subsequently filled into the first concave portion (thin wall portion) 3b. In this manner, the flow of resin through the first concave portion 3b is made uniform. Then, the secondary molding resin flows through the second convex portion 3a′ into the second concave portion (thin wall portion) 3b′ provided on the secondary molded part 3 for improving air-tightness. Thus, at the time of secondary molding, the resin flow is made uniform at the first concave portion (thin wall portion) 3b of the secondary molded part 3 so that the resin flow at the second concave portion (thin wall portion) 3b′ of the secondary molded part 3, where air-tightness is required, also becomes uniform. Therefore, no variation in air-tightness occurs and overall air-tightness is improved. Since the portion where air-tightness is required is thin, pressure and shear-heat generated in the resin become high, so that the protrusion 7 provided on the second convex portion (thick wall portion) 2a′, that is provided on the whole circumference of the portion, where air-tightness of the primary molded part is required for overall air-tightness, tends to melt to a greater extent at the time of secondary molding, leading to better welding of the second convex portion 2a′ to the secondary molded part 3. This improves the air-tightness (adhesion) between the primary molded part 2 and the secondary molded part 3.

Even if the protrusion 7 is not provided, the tip of the second convex portion 2a′ of the primary molded part 2 is melted by the heat of the secondary molding resin and the secondary molded part 3 is thereby welded to the primary molded part 2. However, the protrusion 7 provided on the second convex portion 2a′ of the primary molded part 2 has smaller heat capacity and hence can be melted to a greater extent so that the secondary molded part 3 may be more securely welded to the primary molded part 2.

The molding resin which can be used in the present invention includes general thermoplastic resin such as olefin-type resin, vinyl chloride resin, polyester resin, polyamide resin, ABS resin, polycarbonate resin, acetate resin, fluororesin, etc. Different molding resins may be used for the primary molding and the secondary molding. These resins may include additives such as stabilizers, anti-electrostatics, flame retardants, plasticizers, reinforcing agents, and the like. The insert member can be made of metal, ceramics, or any other suitable material, and there is no special restriction on its size and form.

The shape of the insert member 1, the primary molded part 2 and the secondary molded part 3 is not limited to the above-described example, and various modifications can be made. For example, when the insert member 1 has convexo-concave portions provided on the sides around the center axis (except for the protrusion provided on the circumference of the convex portion beyond the convex portion for regulation of the primary molded part), the surface of the internal section of the primary molded part 2 is formed with convexo-concave portions corresponding to the convexo-concave portions of the insert member 1. In this case, the external surface of the primary molded part 2 may be flat or of convexo-concave shape. When the external surface of the primary molded part 2 is flat, convexo-concave portions may be provided on the external surface of the secondary molded part 3 so that the secondary molded part 3 having at least two sets of convex portion and concave portion can be formed around the primary molded part 2, as described before.

The primary molding resin and the secondary molding resin may be either same resin or different resins.

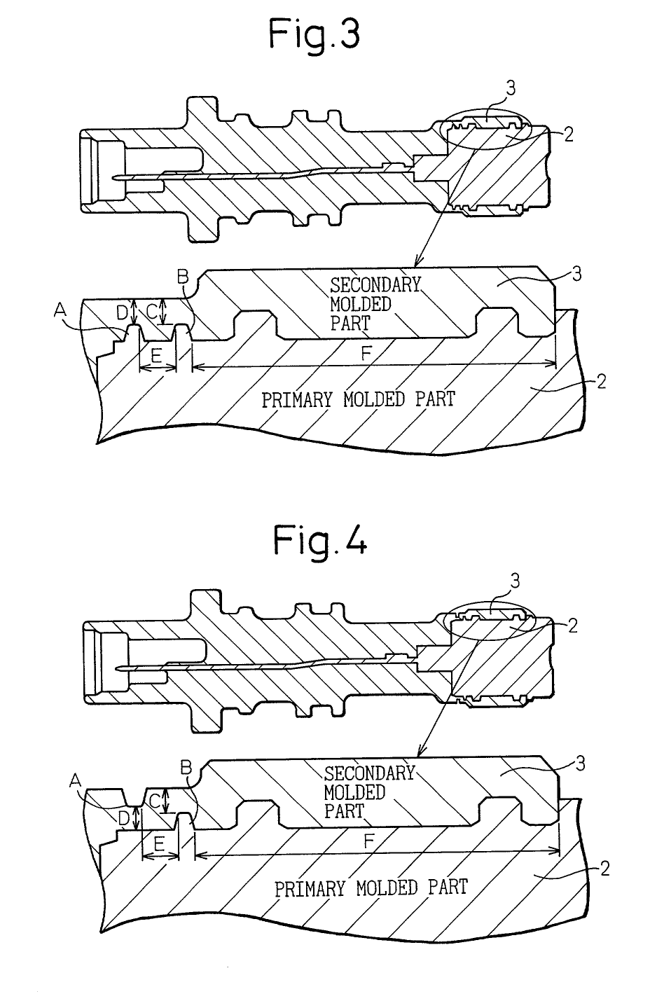

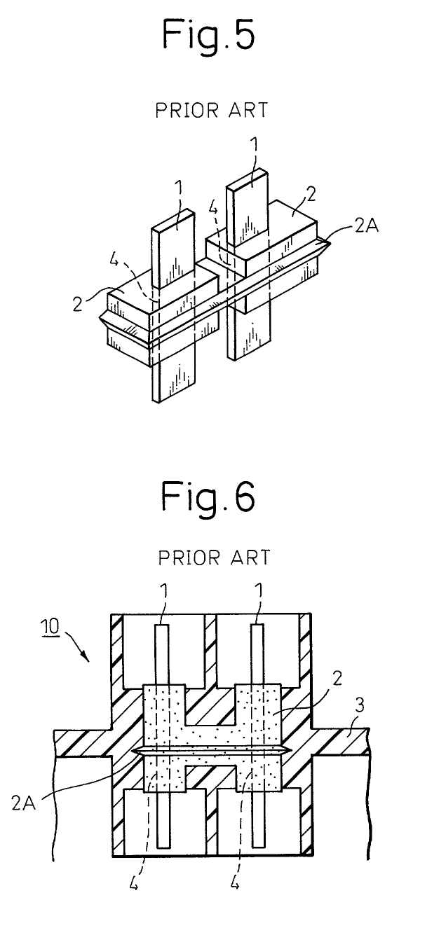

FIGS. 3 and 4 are views showing other embodiments of the present invention, which are focused on the improvement of close contact and air-tightness between the primary molded part 2 and the secondary molded art 3, and do not address the relation between the primary molded part 2 and the insert member 1 specifically as in the previous embodiment (it is an optional matter as to whether or not an insert member is included).

In the resin molded product as shown in FIG. 3, a ring-like protrusion B is formed on the circumferential surface of the primary molded part 2, and on the upstream side of the ring-like protrusion B in the flow of secondary molding resin, a restriction portion D is additionally provided in order to narrow the flow path of the secondary molding resin. In the embodiment as shown in FIG. 3, the restriction portion D is formed by providing a second ring-like protrusion A on the circumferential surface of the primary molded part 2. In the embodiment as shown in FIG. 4, the restriction portion D is formed by providing a portion A of the secondary molded part 3 with a lower thickness than the other portion thereof.

Preferably, the thickness (D) of the restriction portion D of the secondary molded part 3 is less than the separation (E) between the restriction portion D and the first ring-like protrusion B. The portion of the secondary molded part 3 on the downstream side of the thin wall portion C of the secondary molded part 3 formed by the first ring-like protrusion B preferably has a resin thickness at least greater than that of thin wall portion C, and a length (F) of at least three times the thickness (C) of the thin wall portion.

With this construction, at the time of secondary molding, the flow of the secondary molding resin is regulated in the restriction portion D so that timing of arrival of the secondary molding resin at the first ring-like protrusion B of the primary molded part 2 is synchronized over the entire circumference of the ring-like protrusion B. As a result, tip of the ring-like protrusion B is melted approximately at the same time over the entire circumference by the heat of the secondary molding resin, so that welding of the ring-like protrusion B to the secondary molding resin over the complete circumference can be made uniform and stable sealing can be obtained.

Two relatively large protrusions provided in the rear of the first ring-like protrusion are rotation stops formed intermittently on the circumference of the primary molded part 2.

In the embodiments of the present invention as shown in FIGS. 2 to 4, use of the insert member 1 and the primary molded part 2 is not restricted to a single unit. Thus, for example, two, three or more insert members may be set to insert-mold the primary molded part 2, or a combination of separately molded plural primary molded parts may be used as the insert to be insert-molded to the secondary molded part with secondary molding resin.

In the embodiment as shown in FIG. 2, three pairs of convexo-concave portions consisting of a thick wall portion and a thin wall portion are provided on the secondary molded part 3, and a protrusion 7 is provided on the thick wall portion 2a′ of the primary molded part 2 corresponding to the thin wall portion 3b′ of the second pair of the secondary molded part 3.

However, the protrusion 7 may be provided on the thick wall portion 2a″ of the primary molded part 2 corresponding to the thin wall portion 3b″ of the third pair of the secondary molded part 3. With this construction, the flow of secondary molding resin can be more effectively regulated by the thick wall portions 3a, 3a′, and thin wall portions 3b, 3b′ of the first and the second pairs. As a result, the timing of arrival of the secondary molding resin at the protrusion 7 can be more accurately synchronized so that the protrusion 7 can be welded uniformly over the entire circumference.

Also, in the embodiments as shown in FIGS. 3 and 4, the restriction portion D that is provided on the upstream side of the ring-like protrusion B formed on the external circumferential surface of the primary molded part 2 in the flow direction of the secondary molding resin, is not limited to a single restriction, and two or more restriction portions may be provided.

As has been described before, in the insert molded product of the present invention, the air-tightness (close contact) between the insert member and the primary molded part and/or between the primary molded part and the secondary molded part can be improved, so that penetration and leakage of moisture, air, oil or the like through the interfaces, and hence consequent deterioration of insulating resistance, for example, can be avoided.

While the invention has been described by reference to specific embodiments chosen for purposes of illustration, it should be apparent that numerous modifications can be made thereto by those skilled in the art without departing from the basic concept and scope of the invention.

What is claimed is:

1. An insert molded product formed by insert molding of molding resin in two steps of primary molding and secondary molding around an insert member:
wherein a primary molded part formed around said insert member by primary insert molding has convexo-concave shape having at least two sets of thick wall portions of high resin thickness and thin wall portions of low resin thickness formed in the longitudinal direction of said insert member; and
wherein a secondary molded part formed around said primary molded part by secondary insert molding has a convexo-concave shape having at least two sets of thick wall portions of high resin thickness and thin wall portions of low resin thickness formed in the longitudinal direction of said insert member.

2. An insert molded product according to claim 1, wherein said primary molded part and secondary molded part are respectively formed by primary insert molding resin and secondary insert molding resin injected from the thick wall portion in the longitudinal direction of said insert member and successively by flowing through said at least two sets of thick wall portions and thin wall portions.

3. An insert molded product according to claim 2, wherein a protrusion is formed on the circumference of said primary molded part in the portion corresponding to a thin wall portion on the downstream side of said secondary insert molding resin.

4. An insert molded product according to claim 1, wherein a sealant is applied in advance to the circumference of said insert member in the portion to be covered with molding resin in the primary molding.

5. An insert molded product according to claim 1, wherein the cross sectional shape of each of said insert member, said primary molded part and said secondary molded part is polygonal.

6. An insert molded product according to claim 1, wherein the length of the thick wall portion of said primary molded part in the longitudinal direction of said insert member is greater than thickness of said thin wall portion in the direction perpendicular to the longitudinal direction of said insert member.

7. An insert molded product according to claim 1, wherein the length of the thick wall portion of said secondary molded part in the longitudinal direction of said insert member is greater than thickness of said thin wall portion in the direction perpendicular to the longitudinal direction of said insert member.

8. A resin molded product comprising a primary molded part and a secondary molded part formed around said primary molded part:
wherein, relative to the flow direction of secondary molding resin that forms said secondary molded part, a first ring-like protrusion is provided on the circumference of said primary molded part, and a restriction portion is provided for narrowing the flow path of said secondary molding resin on the upstream side of the ring-like protrusion in the resin flow; and
wherein the timing of arrival of said secondary molding resin at said ring-like protrusion is made uniform by regulating the flow of said secondary molding resin with said restriction portion.

9. A resin molded product according to claim 8, wherein said restriction portion is composed by providing a second ring-like protrusion on said primary molded part.

10. A resin molded product according to claim 8, wherein said restriction portion is composed by making a portion of said secondary molded part thinner than the other portion of said secondary molded part.

11. A resin molded product according to claim 8, wherein the thickness of said secondary molded part at said restriction portion is less than the separation between said restriction portion and said first ring-like protrusion.

12. A resin molded product according to claim 8, wherein the secondary molded part on the downstream side in the resin flow relative to the thin wall portion of said secondary molded part formed by said first ring-like protrusion is set to have resin thickness at least greater than the thickness of said thin wall portion, and to have a length not less than three times the thickness of said thin wall portion.
